(19) United States
(12) Patent Application Publication
(10) Pub. No.: US 2015/0063168 A1
(43) Pub. Date: Mar. 5, 2015

(54) METHOD AND APPARATUS FOR SCANNING CHANNEL

(71) Applicant: Samsung Electronics Co., Ltd., Gyeonggi-do (KR)

(72) Inventors: Ik-Soon HWANG, Gyeonggi-do (KR); Dong-Seok OK, Gyeonggi-do (KR); Eun-woo Lee, Gyeonggi-do (KR)

(73) Assignee: Samsung Electronics Co., Ltd.

(21) Appl. No.: 14/476,053

(22) Filed: Sep. 3, 2014

(30) Foreign Application Priority Data
Sep. 3, 2013 (KR) 10-2013-0105726
Sep. 27, 2013 (KR) 10-2013-0115722

(51) Int. Cl. H04W 48/16; H04W 76/02; H04W 4/02

(52) U.S. Cl. CPC H04W 48/16; H04W 4/02; H04W 76/02; H04W 84/12
USPC 370/254

(57) ABSTRACT

A method and terminal device for scanning a channel are provided. According to the method, wireless LAN connection history information is obtained, a channel to be scanned is determined based on the wireless LAN connection history information, and a channel is scanned based on the determined channel.

### PRIORITY

This application claims priority under 35 USC §119 (a) to Korean Patent Application Nos. 10-2013-0105726 and 10-2013-115722, filed on Sep. 3, 2013 and Sep. 27, 2013, respectively, in the Korean Intellectual Property Office, the disclosures of each of which are incorporated herein in their entirety by reference.

### BACKGROUND

1. Field of the Invention

The present invention generally relates to a method and device for determining a channel to be scanned and for scanning the determined channel.

2. Description of the Related Art

A wireless Local Area Network (WLAN) enables data communication using Radio Frequencies (RFs) instead of wires so that terminal devices may wirelessly communicate with each other. A terminal device equipped with a WLAN card may access the Internet without being connected to a communication cable within a specific area.

The terminal device may be connected to an Access Point (AP) so as to access the Internet through the WLAN.

Therefore, the terminal device needs to efficiently detect an available AP to use the WLAN.

### SUMMARY

The present invention has been made to address at least the above described problems and disadvantages, and to provide at least the advantages described below. Accordingly, an aspect of the present invention is to provide a method and device for determining a channel to be scanned and scanning the determined channel, based on wireless LAN connection history information.

Additional aspects will be set forth in part in the description which follows and, in part, will be apparent from the description, or may be learned by practice of the presented embodiments.

According to one or more embodiments of the present invention, a method for scanning a channel includes obtaining wireless LAN connection history information; determining a channel to be scanned based on the wireless LAN connection history information; and scanning a channel based on the determined channel.

The obtaining the wireless LAN connection history information may include: obtaining location information on a terminal device; and obtaining wireless LAN connection history information corresponding to the location information.

The location information may include at least one of a cell ID of a wireless mobile communication base station connected to a terminal device, a location area code (LAC), a routing area code (RAC), and a tracking area code (TAC) of the wireless mobile communication system connected to the terminal device.

The wireless LAN connection history information may include wireless LAN connection history information corresponding to an entire location of a terminal device.

The wireless LAN connection history information may include channel information, wherein the channel information may include at least one of the number of times of connection to an arbitrary access point for each channel, a duration time of connection to the arbitrary access point for each channel, and a time of connection to the arbitrary access point for each channel.

The scanning the channel may include: scanning a channel able to be scanned by a terminal device; and scanning the channel determined based on the wireless LAN connection history information.

The method may further include determining an access point based on a result of the scanning; performing connection to the determined access point; and updating the wireless LAN connection history information based on information on the access point to which the connection is performed.

The wireless LAN connection history information may be updated based on at least one of the number of times of connection to the terminal device for each channel, a duration time of connection to the terminal device for each channel, and a time of connection to the terminal device for each channel.

The scanning the channel may include performing at least one of active scanning in which a probe request message is transmitted to the channel to be scanned and a probe response is received and passive scanning in which a beacon signal is received from the channel to be scanned.

According to one or more embodiments of the present invention, a terminal device includes a control unit configured to obtain wireless LAN connection history information, determine a channel to be scanned based on the wireless LAN connection history information, and scan the channel; and a communication unit configured to scan a channel based on the determined channel.

### BRIEF DESCRIPTION OF THE DRAWINGS

These and/or other aspects and features of the present invention will become apparent and more readily appreciated from the following description of embodiments of the invention, taken in conjunction with the accompanying drawings in which:

FIGS. 1A and 1B are diagrams illustrating a system for performing the channel scanning method according to an embodiment of the present invention;

FIG. 2 is a flowchart illustrating a method for scanning each channel to be scanned through passive scanning or active scanning, according to an embodiment of the present invention;

FIGS. 3 and 4 are flowcharts illustrating a method for determining a channel to be scanned and for scanning the determined channel, according to an embodiment of the present invention;

FIG. 5 is a diagram illustrating an example of wireless LAN connection history information according to an embodiment of the present invention; and

FIGS. 6A and 6B are blocks diagram illustrating an inner structure of a terminal device for performing a channel scanning method according to an embodiment of the present invention.

### DETAILED DESCRIPTION OF EMBODIMENTS OF THE PRESENT INVENTION

Hereinafter embodiments will be described in more detail with reference to the accompanying drawings. In the below description and the accompanying drawings, known functions and configurations are not described in order not to unnecessarily obscure the concept of the present invention. It should be understood that like reference numerals denote like elements.

Prior to the description, it should be understood that the terms used in the specification and the appended claims should not be construed as limited to general and dictionary meanings, but interpreted based on the meanings and concepts corresponding to technical aspects of the present invention on the basis of the principle the terms herein may be defined appropriately for the best explanation. Therefore, the description provided herein is just an example for the purpose of illustration only, and not intended to limit the scope of the invention, so it should be understood that other equivalents and modifications could be made thereto without departing from the spirit and scope of the invention.

In the description, when it is described that a certain part includes certain elements, the part may further include other elements, unless otherwise specified. The term “. . . unit” or “module” denotes a unit for processing at least one function or operation, and may be implemented as hardware or software or a combination thereof.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present invention. Expressions such as “at least one of,” when preceding a list of elements, modify the entire list of elements and do not modify the individual elements of the list.

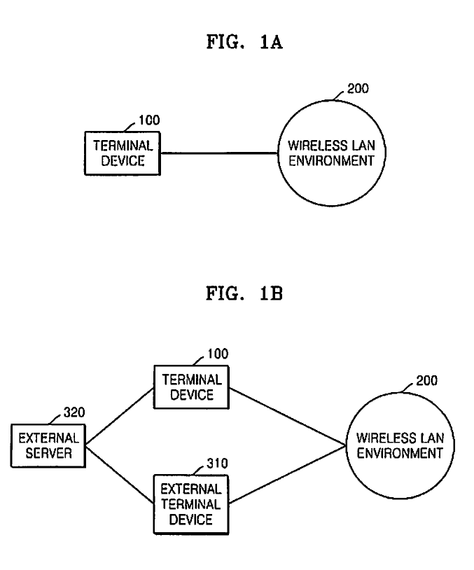

FIGS. 1A and 1B are diagrams illustrating systems for performing a method for scanning a channel according to an embodiment of the present invention.

Referring to FIG. 1A, the system for performing the channel scanning method includes a terminal device 100 and a wireless LAN environment 200.

The terminal device 100 may include various types of devices. For example, the terminal device 100 may include a Personal Computer (PC), a laptop computer, a mobile phone, a tablet PC, a navigation terminal, a smartphone, a Personal Digital Assistant (PDA), a portable multimedia player, and a digital broadcast receiver. However, these devices are merely examples, and thus the terminal device 100 may include other devices with communication functions which are commercialized at the present time or will be developed.

The wireless LAN environment 200 includes at least one access point. The terminal device 100 may be connected to the access point to use Internet service through the wireless LAN.

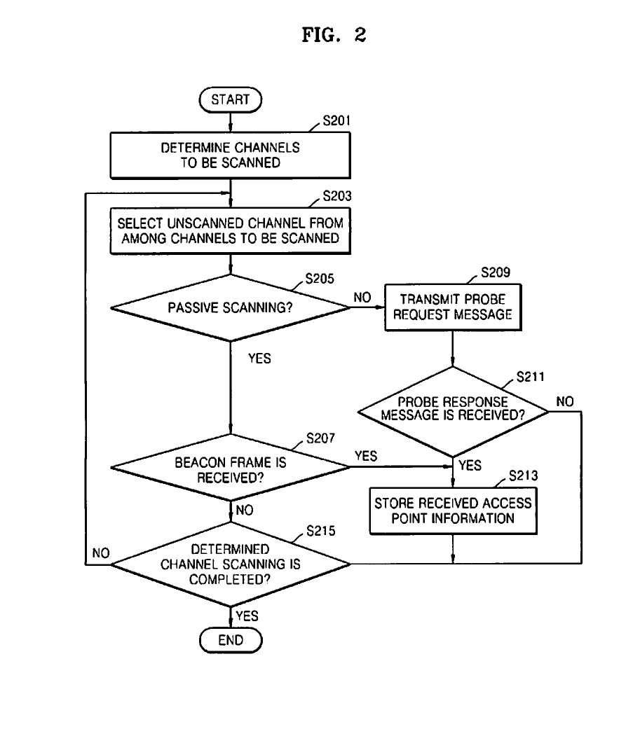

According to an embodiment of the present invention, the terminal device 100 determines a channel to be scanned based on wireless LAN connection history information and scans the determined channel to detect an access point that may be connected to the terminal device 100. Here, the terminal device 100 may scan the channel using a passive scanning method or an active scanning method. A channel scanning method will be described in detail with reference to FIG. 2.

A channel denotes a frequency band used by each access point to transmit/receive data. A frequency band for wireless data communication may be assigned to each access point. The access point transmits/receives data to/from the terminal device 100 through an assigned channel, i.e. a frequency band.

The wireless LAN connection history information includes information on a history of connection between the terminal device 100 and an arbitrary access point. According to an embodiment of the present invention, the wireless LAN connection history information may include location information obtained when the terminal device 100 is connected to the access point and information on a channel used by the access point. Here, the channel information may be present for each location information, and may include channel statistics information related to wireless LAN connection for each channel, such as the number of times of successful connection, the duration of connection, and a recent connection time.

The terminal device 100 may determine a current location, and may determine a channel to be scanned based on the channel information corresponding to the current location. Therefore, the terminal device 100 may preferentially scan a channel that is highly possibly used by an access point available at the current location, using the channel statistics information.

Referring to FIG. 1 B, the system for performing the channel scanning method may include the terminal device 100, the wireless LAN environment 200, an external terminal device 310, and an external server 320

Like the terminal device 100, the external terminal device 310 may be connected to an access point of the wireless environment 200 to use Internet service through the wireless LAN.

According to an embodiment of the present invention, the terminal device 100 may further consider wireless LAN connection history information of the external terminal device 310 to determine a channel to be scanned. That is, the channel statistics information of the wireless LAN connection history information may be generated or updated not only when the terminal device 100 is connected to the wireless LAN but also when the external terminal device 310 is connected to the wireless LAN.

The external server 320 manages the wireless LAN connection history information, and transmits the wireless LAN connection history information to the terminal device 100 or the external terminal device 310 according to a request from the terminal device 100 or the external terminal device 310. When the terminal device 100 or the external terminal device 310 is connected to the wireless LAN environment 200, the external server 320 receives information for updating the wireless LAN connection history information from the terminal device 100 or the external terminal device 310. The information received from the terminal device 100 or the external terminal device 310 may include at least one of location information, channel identification information, wireless LAN connection established time, and duration time of wireless LAN connection of the terminal device 100 or the external terminal device 310. The external server 320 may update the wireless LAN connection history information using the received information. The external server 320 may transmit the updated wireless LAN connection history information to the terminal device 100 or the external terminal device 310 when the terminal device 100 or the external terminal device 310 requests the wireless LAN connection history information to access the wireless LAN.

When the terminal device 100 manages the wireless LAN connection history information, the wireless LAN connection history information of the terminal device 100 or the external terminal device 310 may be stored in a memory of the terminal device 100. The terminal device 100 may request the wireless LAN connection history information of the external terminal device 310 from the external terminal device 310 or the external server 320 in order to update the wireless LAN connection history information stored in the memory of the terminal device 100. The external terminal device 310 receiving the request from the terminal device 100 to provide the wireless LAN connection history information may be present within a certain distance from the terminal device 100 or may be present within the same location unit as the terminal device 100.

For example, the external terminal device 310 may be present at such a location as to obtain the same cell ID as that of the terminal device 100. The cell ID represents identification information of a base station. Therefore, different values of the cell ID may be obtained according to base stations to which the terminal devices are connected.

The method of scanning, by the terminal device 100, a channel using the passive scanning or active scanning method will be described in detail with reference to FIG. 2.

FIG. 2 is a flowchart illustrating the channel scanning method according to an embodiment of the present invention.

The terminal device 100 detects an access point connectable to the terminal device by scanning a channel. The terminal device 100 is connected to the access point to use the Internet service through the wireless LAN.

In step S201, the terminal device 100 may determine a channel to be scanned in order to be connected to the access point. The terminal device 100 may scan all supportable channels. Alternatively, the terminal device 100 may refer to a wireless LAN profile stored in the terminal device 100 to preferentially scan a channel that is present in the profile. The wireless LAN profile is information about a wireless LAN connection history of the terminal device 100 and may include identification information or authentication information of a wireless LAN having a history of connection.

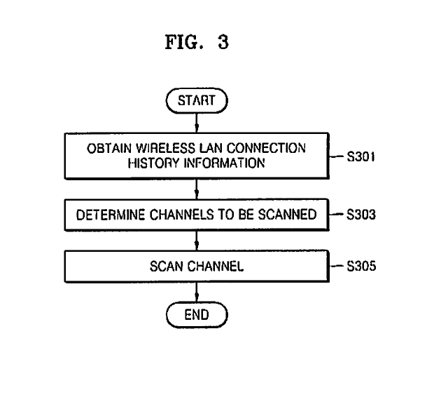

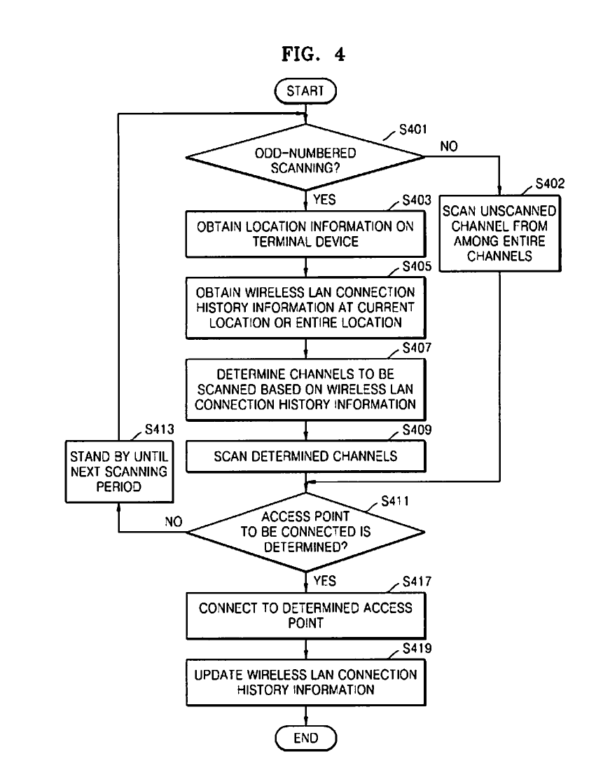

A method of determining, by the terminal device 100, a channel to be scanned will be described in detail with reference to FIGS. 3 and 4.

In step S203, the terminal device 100 may select channels that have not been scanned from among channels determined in step S201. Here, the terminal device 100 may arbitrarily select one of the channels that have not been scanned, or may sequentially select the channels that have not been scanned in an ascending order of frequency. The terminal device 100 is not limited to the above-mentioned methods and may select a channel using various other methods.

In step S205, the terminal device 100 may select the passive scanning method or the active scanning method to scan a channel selected in step S203.

According to an embodiment of the present invention, the passive scanning method or the active scanning method may be used to scan a channel in the terminal device 100. According to the passive scanning method, the terminal device 100 receives a beacon frame from an access point that uses a channel to be scanned so as to scan the channel. According to the active scanning method, the terminal device 100 transmits a probe request message to the access point through the channel to be scanned, and receives a probe response message from the access point so as to scan the channel.

The terminal device 100 may determine whether to perform the passive scanning or the active scanning for each channel to be scanned according to preset configuration information such as a WLAN standard or regional information. For example, in an Android native phone supporting both a 2.4 GHz band and a 5 GHz band, the active scanning may be performed on channels 1-13 of the 2.4 GHz band and channels 36-48 and 149-161 of the 5 GHz band at a period of about 15 seconds. The passive scanning may be performed on the other channels of the 5 GHz band.

According to an embodiment of the present invention, the channel scanning method for detecting an accessible access point is not limited to the passive scanning or active scanning method, and thus other various methods may be used to scan a channel.

In step S207, when passive scanning is performed on a channel selected in step S203, the terminal device 100 receives a beacon frame through the channel selected in step S203.

The beacon frame received by the terminal device 100 in step S207 may be periodically broadcast from the access point through the channel selected in step S203. A period of the broadcasting may be, for example, about 100 ms.

The beacon frame may include information on the access point from which the beacon frame is broadcast. For example, the beacon frame may include a service set identifier (SSID) of the access point, a time stamp, and period information. The time stamp may include information on a transmission time of the beacon frame. The beacon frame may also include information for determining whether an SSID included in a wireless LAN profile matches the SSID of the access point that has transmitted the beacon frame.

When at least one beacon frame is not received in step S207 through the channel selected in step S203 for a certain period of time, it may be determined whether the scanning has been performed on the channels determined to be scanned, in step S215. When the scanning operation on the determined channels is completed, the process may be finished. When there still remains a channel to be scanned among the determined channels, the terminal device 100 returns to step S203 to repeatedly perform step S203 to step S215.

If the terminal device 100 does not select passive scanning in step S205, active scanning is performed in step S209 on the channel selected in step S203, and the terminal device 100 transmits the probe request message to a specific or arbitrary access point through the channel selected in step S203.

The access point that has received the probe request message transmitted in step S209 transmits a probe response message as a response to the probe request message. In step S211, the terminal device 100 may receive the probe response message for the probe request message transmitted in step S209. The probe response message may be received within about 15 ms after the probe request message is transmitted. The terminal device 100 may receive at least one probe response message.

The probe response message may include information on the access point transmitting the probe response message and information for determining whether the SSID included in the wireless LAN profile matches the SSID of the access point.

In step S211, if at least one probe response message is not received by the terminal device 100 through the channel selected in step S203 for a certain period of time, it may be determined whether scanning has been performed on all the channels determined to be scanned, in step S215. When the scanning operation on all the determined channels is completed, the process may be finished. When there still remains a channel to be scanned among the channels determined in step S201, the terminal device 100 returns to step S203 to repeatedly perform step S203 to step S215.

In step S211, if at least one probe response message is received, the terminal device 100 may store information in step S213 on access points obtained through the channel scanning using the beacon frame or the probe response message received in step S207 or step S211.

Hereinafter a method for determining, by the terminal device 100, a channel to be scanned and for determining an access point by scanning the determined channel will be described with reference to FIGS. 3 and 4.

FIGS. 3 and 4 are flowcharts illustrating the method for determining a channel to be scanned and for scanning the determined channel, according to an embodiment of the present invention.

Referring to FIG. 3, in step S301, the terminal device 100 may obtain the wireless LAN connection history information.

According to an embodiment of the present invention, the wireless LAN connection history information may include wireless LAN connection history information on the terminal device 100 or the external terminal device 310 capable of connecting a wireless LAN and at least one access point.

The wireless LAN connection history information may include location information on the terminal device 100 or the external terminal device 310 when the terminal device 100 or the external terminal device 310 is connected to the access point. The location information includes a cell ID of a base station connected to the terminal device 100 or the external terminal device 310, in order to receive mobile communication service. The cell ID of the base station connected to the terminal device 100 or the external terminal device 310 may be included in the wireless LAN connection history information as the location information when the terminal device 100 or the external terminal device 310 is connected to the access point. Here, the wireless LAN connection history information may further include signal strength information of the base station for more precisely providing a location of the terminal device 100 or the external terminal device 310.

The location information on the terminal device 100 or the external terminal device 310 in the wireless LAN connection history information is not limited to the cell ID. The location information included in the wireless LAN connection history information may include various information such as an enhanced cell ID and a Location Area Code (LAC), a Routing Area Code (RAC), and a Tracking Area Code (TAC) of a wireless mobile communication system to which the terminal device 100 is connected.

The wireless LAN connection history information also includes channel information. The channel information may include at least one of the number of times of connection to the terminal device 100 or the external terminal device 310 for each channel, a duration time of connection to the terminal device 100 or the external terminal device 310 for each channel, and a time of connection to the terminal device 100 or the external terminal device 310 for each channel.

The number of times of connection to the terminal device 100 or the external terminal device 310 for each channel represents the number of times of successful connection of the terminal device 100 or the external terminal device 310 to an access point by scanning each channel. In other words, the number of times of connection for each channel represents the number of times of providing wireless LAN Internet service to the terminal device 100 or the external terminal device 310 through a connected access point for each channel.

The duration time of connection to the terminal device 100 or the external terminal device 310 for each channel represents a time during which connection between the terminal device 100 or the external terminal device 310 and the access point is maintained when the terminal device 100 or the external terminal device 310 scans each channel and is connected to the access point. In other words, the duration time of connection for each channel represents a time during which the wireless LAN Internet service is provided to the terminal device 100 or the external terminal device 310 while the connection between the terminal device 100 or the external terminal device 310 and the access point is maintained.

The time of connection to the terminal device 100 or the external terminal device 310 for each channel may include a time stamp of a recent time at which the terminal device 100 or the external terminal device 310 has been connected to the access point by scanning each channel. In other words, the time of connection for each channel represents a recent time at which the terminal device 100 or the external terminal device 310 has been provided with the wireless LAN Internet service by being connected to the access point. Therefore, the time of connection for each channel may represent a time at which the connection to the access point is released and the wireless LAN Internet service is finished.

The channel information included in the wireless LAN connection history information may be divided according to the location information on the terminal device 100 or the external terminal device 310. That is, the channel information may be divided according to the location information obtained when the terminal device 100 or the external terminal device 310 is connected to the access point.

In step S303, the terminal device 100 determines a channel to be scanned based on the wireless LAN connection history information obtained in step S301.

For example, the terminal device 100 may obtain the cell ID of a base station that is currently connected to the terminal device 100 or the channel information corresponding to current location information on the terminal device 100, from the wireless LAN connection history information obtained in step S301. The terminal device 100 may determine a channel to be scanned based on at least one of the number of times of connection, the duration time of connection, and the connection time of a channel at a current location included the obtained channel information. Therefore, according to an embodiment of the present invention, the terminal device 100 may preferentially scan a channel at which an available access point may be highly possibly detectable, based on the wireless LAN connection history information.

In detail, the terminal device 100 may determine a channel to be scanned based on whether the number of times of connection is large, the duration time of connection is long, and the connection time is recent. The terminal device 100 may determine a priority order of scanning channels that may be scanned using the channel information. For example, the terminal device 100 may determine a channel of which the connection time is most recent as a highest-priority channel and may determine a channel of which the connection time is not recent but of which the connection duration time is long or the number of times of connection is large as a next-highest-priory channel, in order to perform scanning at a next period.

However, the method of prioritizing channels to be scanned is not limited thereto. The priority order may be determined based on the connection duration time or the number of times of connection according to a setting. Furthermore, the terminal device 100 may determine a channel to be scanned based on various types of information without being limited to the above-mentioned channel information.

The terminal device 100 may obtain the channel information on a channel able to be scanned at an entire location, from the wireless LAN connection history information obtained in step S301. The obtained channel information may be the channel information on a channel connected to the terminal device 100 at a previous time without consideration of current location information.

Therefore, the terminal device 100 may obtain the channel information from the wireless LAN connection history information without consideration of the current location information on the terminal device 100. The terminal device 100 may determine a channel to be scanned based on the number of times of connection, the connection duration time, and the connection time of a channel of the terminal device 100 using the obtained channel information. Prioritizing channels to be scanned at the entire location may be performed in the same manner as mentioned above with respect to the prioritizing channels to be scanned at a current location.

In step S305, the terminal device 100 may scan the channel determined to be scanned in step S303 using the passive scanning method or the active scanning method. As a result of the scanning, when the terminal device 100 cannot detect an access point or fails in authentication and thus there is no available access point, the terminal device 100 may determine a channel to be scanned again. For example, the terminal device 100 may scan the next-highest-priority channel determined in step S303. Determining a channel to be scanned again and scanning the determined channel may be performed after standing by until a next period begins according to a channel scanning period.

Hereinafter a method for determining a channel to be scanned and for scanning the determined channel will be described with reference to FIG. 4.

Steps S405, S407, and S409 of FIG. 4 correspond to steps S301, S303, and S305 of FIG. 3, respectively.

Referring to FIG. 4, in step S401, when the terminal device 100 scans channels, the terminal device 100 may determine whether to perform odd-numbered scanning in order to detect an access point. When the terminal device 100 performs the odd-numbered scanning, the terminal device 100 may determine a channel to be scanned in consideration of the wireless LAN connection history information.

On the contrary, when the terminal device 100 performs even-numbered scanning, the terminal device 100 may scan at least one of channels that may be scanned by the terminal device 100, in step S402. For example, the terminal device 100 may scan all channels that may be scanned.

According to an embodiment of the present invention, the terminal device 100 may perform both a method of preferentially scanning a channel determined based on the wireless LAN connection history information and a method of scanning at least one of all channels that may be scanned by the terminal device 100. As described above, a channel to be scanned is determined according to the odd-numbered scanning or the even-numbered scanning. However, an embodiment of the present invention is not limited thereto, and thus a channel to be scanned may be determined using other methods. For example, the method of scanning at least one channel may be performed once whenever the method of preferentially scanning a channel determined based on the wireless LAN connection history information is performed twice. Therefore, the terminal device 100 may perform various methods for determining a channel and for scanning the determined channel.

In step S403, the terminal device 100 may obtain the current location information on the terminal device 100. The current location information on the terminal device 100 includes the cell ID information on a mobile communication base station to which the terminal device 100 is currently connected.

In addition, the current location information on the terminal device 100 may include at least one of cell ID information, a Location Area Code (LAC), a Routing Area Code (RAC), and a Tracking Area Code (TAC) of the wireless mobile communication system to which the terminal device 100 is currently connected.

In step S405, the terminal device 100 may obtain the wireless LAN connection history information corresponding to the entire location or the current location.

The wireless LAN connection history information for the entire location may include information on at least one channel connectable to the terminal device 100, regardless of the current location of the terminal device 100. That is, the wireless LAN connection history information for the entire location may include the channel information on a channel having a history of wireless LAN connection from among channels connectable to the terminal device 100.

The wireless LAN connection history information for the current location may include the channel information on at least one channel which has a history of wireless LAN connection and is able to be connected to the terminal device 100 at the current location of the terminal device 100. That is, the wireless LAN connection history information for the current location may include the channel information on a channel having a history of wireless LAN connection to the terminal device 100 or the external terminal device 310 within the current location. In other words, the wireless LAN connection history information for the current location may include the channel information on a channel used by an access point having a history of wireless LAN connection to the terminal device 100 or the external terminal device 310 within the current location.

As described above, the channel information may include at least one of the number of times of connection between an arbitrary device and the access point for each channel, the duration time of connection between the arbitrary device and the access point for each channel, and the time of connection between the arbitrary device and the access point for each channel. Here, the arbitrary device may be the terminal device 100 or the external terminal device 310.

According to an embodiment of the present invention, the wireless LAN connection history information may include the location information on the terminal device 100 when the terminal device 100 is connected to the access point.

The location information may include the cell ID of a base station connected to the terminal device 100 for using the mobile communication service. That is, the cell ID of the base station connected to the terminal device 100 may be included in the wireless LAN connection history information as the location information when the terminal device 100 is connected to the access point. Here, the wireless LAN connection history information may further include signal strength information of the base station for more precisely providing a location of the terminal device 100.

According to an embodiment of the present invention, the location information on the terminal device 100 in the wireless LAN connection history information may include various types of information for providing the location information on the terminal device 100, such as the cell ID, the LAC, the RAC, and the TAC. The wireless LAN connection history information may include the channel information. The channel information may include at least one of the number of times of connection to the terminal device 100 for each channel, the duration time of connection to the terminal device 100 for each channel, and the time of most recent connection to the terminal device 100 for each channel. The number of times of connection to the terminal device 100 for each channel may represent the number of times of providing the wireless LAN internet service to the terminal device 100 through a connected access point for each channel.

The duration time of connection to the terminal device 100 for each channel may represent the duration time of providing the wireless LAN internet service to the terminal device 100 while the connection to the access point is maintained for each channel.

The time of most recent connection to the terminal device 100 may include a time stamp of a most recent time at which the terminal device 100 has been connected to the access point for each channel.

According to an embodiment of the present invention, the wireless LAN connection history information may not be limited to information corresponding to the current location of the terminal device 100, and may information corresponding to the entire location regardless of the current location of the terminal device 100. That is, the wireless LAN connection history information may include the channel information on a channel having a history of wireless LAN connection at the entire location from among channels connectable to the terminal device 100.

In step S407, the terminal device 100 may determine a channel to be scanned based on the wireless LAN connection history information. As described above, the terminal device 100 may determine a channel to be scanned based on the number of times of connection, the connection duration time, and the connection time of a channel at the current location of the terminal device 100 or the entire location using the channel information obtained in step S405.

In addition, it may be determined whether to determine a channel to be scanned in consideration of the channel information for the current location, or to determine a channel to be scanned in consideration of the channel information for the entire location, according to a predefined algorithm or preset information. That is, the terminal device 100 may use a predefined algorithm to determine which one of these methods allows the terminal device 100 to detect an access point more rapidly. The method of determining whether to determine a channel to be scanned in consideration of the channel information for the current location, or to determine a channel to be scanned in consideration of the channel information for the entire location, is not limited thereto, and thus various other methods may be used.

In step 5407, the terminal device 100 determines at least one channel to be scanned, may also determine a priority order of scanning channels based on the wireless LAN connection history information.

In step S409, the terminal device 100 may scan the channels determined in step S407. The terminal device 100 may perform the passive scanning or the active scanning according to a channel. The terminal device 100 may determine whether to perform the passive scanning or the active scanning according to the WLAN standard or preset configuration information and a channel to be scanned.

Once at least one channel to be scanned is determined in step S407, the terminal device 100 may scan the determined channels according to the priority order in step S409. Herein, the channel scanning may be performed periodically.

In step S411, the terminal device 100 may determine an access point to be connected thereto as a result of the channel scanning in steps S402 or S409.

In step S411, if the terminal device 100 cannot detect the access point or fails in authentication and thus fails connect to the access point as a result of the channel scanning, the terminal device 100 may stand by until a next scanning period begins in step S413, and then returns to step S401 to determine a channel to be scanned again.

If an access point is determined in step S411, the terminal device 100 may perform connection to the determined access point in step S417 so as to use the Internet service through the wireless LAN. Here, the terminal device 100 may perform authentication, and may be connected to the access point when the authentication is successful. For example, the terminal device 100 may perform the authentication for the access point using a password stored in the wireless LAN profile or a password input by a user.

When the authentication fails, the terminal device 100 may return to operation S413, may stand by until a next scanning period begins, and may repeat a channel scanning procedure. Alternatively, the terminal device 100 may request the user to input the password again.

When the terminal device 100 is connected to the access point in step S417, the terminal device 100 may update the wireless LAN connection history information in step S419. In detail, the terminal device 100 may update the channel information that may be included in the wireless LAN connection history information.

The terminal device 100 may increase the number of times of connection to the channel used by the currently connected access point by as much as one, to update the channel information on the current location of the terminal device 100. The terminal device 100 may update the time of recent connection to the channel used by the currently connected access point with the time at which the connection to the currently connected access point is released after being established. When the connection to the currently connected access point is released, the terminal device 100 may measure the duration time of connection to the currently connected access point and may update the connection duration time of the channel used by the currently connected access point with a measured value. For example, the connection duration time of the channel may be updated with an average value of measured connection duration times.

In step S419, when the terminal device 100 stores the wireless LAN connection history information in the memory of the terminal device 100, the wireless LAN connection history information stored in the memory is updated.

Alternatively, in the case where the terminal device 100 receives the wireless LAN connection history information from the external server 320 or the external server 320 manages the wireless LAN connection history information, information for updating the wireless LAN connection history information may be transmitted to the external server 320. The information transmitted to the external server 320 includes at least one of the current location information on the terminal device 100, the identification information on the currently connected channel, the time at which the connection between the current channel and the access point has been established, and the duration time of connection to the currently connected access point. When the external server 320 receives the above-mentioned information from the terminal device 100, the external server 320 may update the wireless LAN connection history information using the received information.

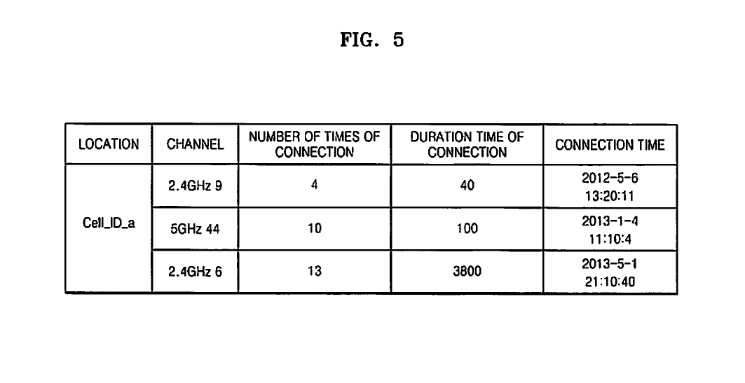

FIG. 5 is a diagram illustrating an example of the wireless LAN connection history information in a location Cell_ID_a according to an embodiment of the present invention.

Referring to FIG. 5, the wireless LAN connection history information in the location Cell_ID_a may include the channel information used when the terminal device 100 is connected to the access point.

The wireless LAN connection history information may include the number of times of connection, the connection duration time, and the connection time for each channel, and may be divided according to a location of the terminal device 100 on which wireless LAN connection has been performed.

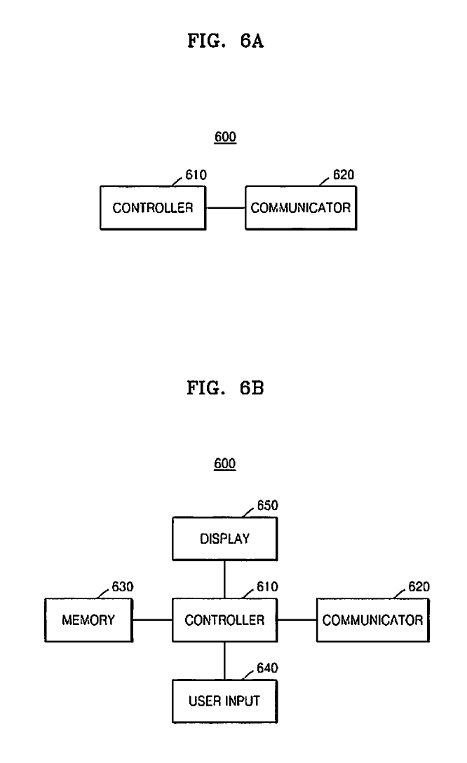

An inner structure of the terminal device 100 will be described with reference to FIG. 6.

FIGS. 6A and 6B are block diagrams illustrating an inner structure of a terminal device for performing the channel scanning method according to an embodiment of the present invention.

Referring to FIG. 6A, a terminal device 600 may include a controller 610 and a communicator 620. However, the terminal device 600 may include more elements or may include less elements than the illustrated elements.

The controller 610 may control the overall operation of the terminal device 600. For example, the controller 610 performs control and process related to connection to a wireless LAN, such as the channel scanning method for the wireless LAN connection described above with reference to FIGS. 2 to 4. That is, the controller 610 controls the overall operation of communicator 620.

According to an embodiment of the present invention, the controller 610 obtains wireless LAN connection history information and determines a channel to be scanned based on the wireless LAN connection history information. The controller 610 determines an access point to be connected to the terminal device 600 based on a result of scanning, by the communicator 620.

The controller 610 may also obtain the wireless LAN connection history information corresponding to location information obtained by the communicator 620.

The controller 610 stores the wireless LAN connection history information based on information on the access point connected to the terminal device 600.

The communicator 620 may include at least one element enabling communication between the terminal device 600 and the wireless LAN environment 200. For example, the communicator 620 may include a mobile communication module, a wireless LAN module, and a short-range communication module.

The mobile communication module transmits/receives radio signals to/from at least one of a base station, an external terminal, and a server on a mobile communication network. Here, the radio signal may include various types of data according to transmission of a voice call signal, a video call signal, or character/multimedia messages.

The wireless LAN module represents a module for wireless LAN connection and may be internally or externally included in the terminal. The short-range communication module represents a module for short-range communication. A short-range communication technology such as Bluetooth, Radio Frequency IDentification (RFID), Infrared Data Association (IrDA), Ultra WideBand (UWB), or ZigBee may be used.

When the communicator 620 is connected to a base station transmitting/receiving radio signals, the communicator 620 may receive cell ID information on the base station from the base station so as to obtain location information on the terminal device 600. The communicator 620 scans a channel based on a channel determined by the controller 610, or may scan a channel able to be scanned by the terminal device 600, by performing at least one of the active scanning and the passive scanning methods, and may be connected to the access point determined by the controller 610.

Referring to FIG. 6B, the terminal device 600 may include the controller 610, the communicator 620, a memory 630, a user input 640, and a display 650. However, the terminal device 600 may include more elements or may include less elements than the illustrated elements. The controller 610 and the communicator 620 of FIG. 6B correspond to the controller 610 and the communicator 620 of FIG. 6A.

The memory 630 may store a program for the process and control of the controller 610 and may store input/output data (e.g., captured data, phonebook, message, still image, video, etc).

The memory 630 may include at least one of storage media such as a flash memory, a hard disk, a multimedia card micro, a card-type memory (e.g. SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The terminal device 600 may operate web storage for performing a storage function of the memory 630 on the Internet.

The memory 630 stores the wireless LAN connection history information used to scan a channel.

The user input 640 generates input data for controlling the terminal device 600. The user input 640 may include a keypad, a dome switch, a touchpad (resistive/capacitive type), a jog wheel, a jog switch, and a button. In particular, in the case where the touchpad forms a layered structure together with the display 650, this structure may be referred to as a touch screen. The user input 640 may receive a wireless LAN connection request or a password for authentication from a user.

The display 650 displays and outputs information processed in the terminal device 600. The display 650 may display a list of access points connectable to the terminal device 600 and a UI and a GUI related to an authentication procedure for performing connection to an access point.

As described above, when the display 650 and the touchpad have a layered structure to form the touch screen, the display 650 may be used not only as an output device but also an input device. The display 650 includes at least one of a Liquid Crystal Display (LCD), a Thin Film Transistor-Liquid Crystal Display (TFT-LCD), an Organic Light-Emitting Diode (OLED), a flexible display, and a 3D display. According to a type of the terminal device 600, two or more displays 650 may be provided. The touch screen may be configured so as to detect not only a location and an area of a touch but also pressure of the touch. Furthermore, the touch screen may be configured so as to detect not only a real touch but also a proximity or a hovering touch.

Herein, the real touch represents a case where an input device such as a pointer actually touches a screen, and the proximity touch represents a case where the pointer does not actually touches the screen but approaches the screen within a certain distance. Herein, the pointer represents a tool for touching a part of the screen or proximately touching the screen. For example, the pointer may include a stylus pen and finger.

According to an embodiment of the present invention, an access point connectable to the terminal device 100 or 600 may be rapidly detected.
According to an embodiment of the present invention, a channel for detecting an access point that is highly possibly connectable to the terminal device 100 or 600 at a current location may be preferentially scanned.

The method according to an embodiment of the present invention may be implemented as a code on a recording medium readable by a computer (including devices having a function of information processing). The computer-readable recording medium includes any type of a recording device for storing data readably by a computer system. The computer-readable recording medium includes a ROM, a RAM, a CD-ROM, a magnetic tape, a floppy disk, and an optical data storage device.

It should be understood that the embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method for scanning a channel, comprising:
obtaining wireless LAN connection history information;
determining a channel to be scanned based on the wireless LAN connection history information; and
scanning a channel based on the determined channel.

2. The method of claim 1, wherein obtaining the wireless LAN connection history information comprises:
obtaining location information on a terminal device; and
obtaining wireless LAN connection history information corresponding to the location information.

3. The method of claim 2, wherein the location information comprises at least one of a cell ID of a base station of a wireless mobile communication system connected to a terminal device, a Location Area Code (LAC), a Routing Area Code (RAC), and a Tracking Area Code (TAC) of the wireless mobile communication system to which the terminal device is connected.

4. The method of claim 1, wherein the wireless LAN connection history information comprises wireless LAN connection history information corresponding to an entire location of a terminal device.

5. The method of claim 1, wherein the wireless LAN connection history information comprises channel information, wherein the channel information comprises at least one of the number of times of connection to an arbitrary access point for each channel, a duration time of connection to the arbitrary access point for each channel, and a time of connection to the arbitrary access point for each channel.

6. The method of claim 1, wherein scanning the channel comprises:
scanning a channel able to be scanned by a terminal device; and
scanning the channel determined based on the wireless LAN connection history information.

7. The method of claim 1, further comprising:
determining an access point based on a result of the scanning;
performing connection to the determined access point; and
updating the wireless LAN connection history information based on information on the access point to which the connection is performed.

8. The method of claim 7, wherein the wireless LAN connection history information is updated based on at least one of the number of times of connection of a terminal device to the access point for each channel, a duration time of connection of the terminal device to the access point for each channel, and a time of connection of the terminal device to the access point for each channel.

9. The method of claim 1, wherein scanning the channel comprises performing at least one of active scanning in which a probe request message is transmitted to the channel to be scanned and a probe response is received, and passive scanning in which a beacon signal is received from the channel to be scanned.

10. A terminal device comprising:
a controller configured to obtain wireless LAN connection history information, determine a channel to be scanned based on the wireless LAN connection history information, and scan the channel; and
a communicator configured to scan a channel based on the determined channel.

11. The terminal device of claim 10, wherein the communicator obtains location information on the terminal device, and the controller obtains wireless LAN connection history information corresponding to the location information.

12. The terminal device of claim 11, wherein the location information comprises at least one of a cell ID of a base station of a wireless mobile communication system connected to the terminal device, a Location Area Code (LAC), a Routing Area Code (RAC), and a Tracking Area Code (TAC) of the wireless mobile communication system to which the terminal device is connected.

13. The terminal device of claim 10, wherein the wireless LAN connection history information comprises channel information, wherein the channel information comprises at least one of the number of times of connection to an arbitrary access point for each channel, a duration time of connection to the arbitrary access point for each channel, and a time of connection to the arbitrary access point for each channel.

14. The terminal device of claim 10, wherein the communicator scans a channel able to be scanned by the terminal device or scans the determined channel.

15. The terminal device of claim 10, wherein the communicator performs connection to an access point determined by the controller based on a result of the scanning, and the control unit determines the access point based on the result of the scanning and updates the wireless LAN connection history information based on information on the access point to which the connection is performed.

16. The terminal device of claim 15, wherein the wireless LAN connection history information is updated based on at least one of the number of times of connection of the terminal device to the access point for each channel, a duration time of connection of the terminal device to the access point for each channel, and a time of connection of the terminal device to the access point for each channel.

17. The terminal device of claim 10, wherein the communicator performs at least one of active scanning in which a probe request message is transmitted to the channel to be scanned and a probe response is received, and passive scanning in which a beacon signal is received from the channel to be scanned.

18. A computer-readable recording medium for recording a program thereon for implementing a channel scanning method, the method comprising the steps of:
obtaining wireless LAN connection history information;
determining a channel to be scanned based on the wireless LAN connection history information; and
scanning a channel based on the determined channel.
